(19) United States
(12) Patent Application Publication
(10) Pub. No.: US 2024/0398652 A1
(43) Pub. Date: Dec. 5, 2024

(54) AXILLARY CRUTCH DEVICE, SYSTEM, KIT, AND METHOD FOR HANDS-FREE MOBILITY AND ITEM CARRYING

(71) Applicant: THE CRUTCH COMPANION COMPANY, North Vancouver (CA)

(72) Inventors: Keivan Hirji, North Vancouver (CA); Jason Jaffer, Vancouver (CA)

(21) Appl. No.: 18/733,401

(22) Filed: Jun. 4, 2024

Related U.S. Application Data
(60) Provisional application No. 63/470,911, filed on Jun. 4, 2023.

(51) Int. Cl. A61H 3/02

(52) U.S. Cl. CPC A61H 3/02; A61H 2201/0107; A61H 2201/1638

(57) ABSTRACT

The disclosure relates to an innovative crutch attachment designed to enhance the functionality of traditional axillary crutches. This attachment allows users to operate the crutch hands-free, thereby improving mobility and independence. The device features an ergonomically designed structure that can be easily attached to existing crutches, enabling users to maneuver the crutch using their forearm or wrist instead of the conventional hand grip. This design reduces the need for hand engagement, allowing the user to have their hand free to carry items they otherwise could not carry in transit such as cups and plates. The attachment is adjustable and can be customized to fit various crutch styles and user preferences, ensuring a wide range of applicability and ease of use. This disclosure addresses the limitations of current crutch designs by providing a simple, effective solution for enhancing user mobility, convenience, functionality, and quality of life during recovery periods.

### CROSS-REFERENCE TO RELATED APPLICATIONS

This application claims the benefit of U.S. Provisional Application No. 63/470,911, filed on Jun. 4, 2023. The entire disclosure of the above application is hereby incorporated herein by reference.

### FIELD

The present technology relates to medical assistive devices, and, more particularly, to improvements in axillary crutches for enhanced user mobility and functionality.

### INTRODUCTION

This section provides background information related to the present disclosure which is not necessarily prior art.

Axillary crutches are well-known mobility aides that allow individuals recovering from leg or foot injuries to move around by transferring their body weight from their injured leg or foot to their arms and shoulders. Millions of individuals rely on axillary crutches annually to aid mobility during recovery from leg, foot, or lower body injuries. The average length of use of the axillary crutches is usually several consecutive weeks immediately following the injury.

While axillary crutches have been essential in providing support and balance, they unfortunately require users to engage both hands to operate, which significantly restricts the ability to perform everyday tasks such as carrying items or handling objects, thus impacting the user's independence and quality of life.

The design of axillary crutches has also seen minimal innovation over the years. Users often experience discomfort and fatigue due to the underarm pressure and the necessity to use hands continuously for support and movement. The requirement to use their hands to operate the crutch prevents them from simultaneously carrying items that require the use of their hand, including common household items like cups and plates. This also significantly interferes with, or outright prevents users from, performing key activities of daily living including shopping, housekeeping, and meal preparation, since they cannot use their hands to carry items. As a result, they are often forced to rely on others for help and lose their sense of freedom and independence in the process.

The few attempts that have been made to modify axillary crutches to allow hands-free operation or to provide means to carry objects have involved complex mechanisms or additions that can compromise the stability and ease of use of the crutch, adding weight or altering the balance, which can lead to increased risk of accidents or further injury.

One such attempt is documented in U.S. Published Application No. 2004/0011392, filed by inventors John H. Maulden and Cathy H. Hudson on Jun. 19, 2003. Their application proposes a crutch with a hands-free attachment that includes a peg for forearm engagement to facilitate carrying items. While this publication addresses the need to free up the hands, it introduces issues such as potential discomfort in forearm use and the complexity of the attachment mechanism, which may not provide the necessary stability and case of adjustment required by users of varying physical capabilities.

Furthermore, many of these modified axillary crutches do not adequately address the ergonomic needs of the user, leading to additional strain on various parts of the body. Users often report increased fatigue and discomfort, particularly in the underarm area, wrists, and hands, which can deter from the long-term use of such devices.

There is a continuing need for an improvement in axillary crutch design that enhances user independence without compromising safety or comfort. Desirably, such an improvement would offer a simple, ergonomic solution that allows for hands-free operation while ensuring stability, comfort, and adaptability to accommodate a wide range of user needs and body types. The ideal solution would seamlessly integrate into the daily life of the user, supporting a more active and self-sufficient lifestyle even during recovery periods.

### SUMMARY

In concordance with the instant disclosure, an improvement in axillary crutch design that enhances user independence without compromising safety or comfort, and which offers a simple, ergonomic solution that allows for hands-free operation while ensuring stability, comfort, and adaptability to accommodate a wide range of user needs and body types, and which seamlessly integrates into the daily life of the user, supporting a more active and self-sufficient lifestyle even during recovery periods, has surprisingly been discovered.

The present technology includes articles of manufacture, systems, and processes that relate to the development of advanced mobility aids, specifically designed to enhance the functionality and comfort of traditional crutches, enabling hands-free operation and improved user independence.

In one embodiment, the crutch device for hands-free carrying of an item by a user comprises an elongate support structure and an attachment body. The attachment body includes an upright receiving portion configured to receive an upright of an axillary crutch, and a support structure receiving portion designed to receive the elongate support structure. This configuration facilitates the attachment of the elongate support structure to the axillary crutch in a laterally-oriented position, enabling hands-free use and enhancing the user's mobility and convenience.

In another embodiment, an axillary crutch system includes the crutch device as previously described. This system enhances the functionality of traditional axillary crutches by allowing the user to carry items hands-free while using the axillary crutch. The integration of the crutch device with axillary crutches provides a seamless and efficient solution for users needing mobility support and item carrying capability simultaneously.

In a further embodiment, a kit for the crutch device is provided for hands-free carrying of an item by a user. The kit includes an elongate support structure, an attachment body, and a connection mechanism, such as a threaded bolt and a wingnut, all configured for easy installation on an axillary crutch. This kit enables users to modify existing axillary crutches to incorporate the hands-free item carrying functionality, offering a practical solution for enhancing the utility of conventional crutches.

In yet another embodiment, a method of attaching the crutch device to an axillary crutch involves providing a kit containing the necessary components for installation. The method includes steps such as aligning the attachment body with the upright of the axillary crutch, securing the attachment body to the axillary crutch using a connection mechanism, and positioning the elongate support structure in the laterally-oriented position within the support structure receiving portion. This method facilitates the transformation of standard axillary crutches into versatile tools that allow users to carry items hands-free, thereby enhancing mobility and independence.

In an exemplary embodiment, the present disclosure introduces a transformative addition to axillary crutches, enhancing user mobility by facilitating hands-free operation. This embodiment features a solid tubed “J” shaped aluminum structure designed to attach or be permanently affixed to the front of an axillary crutch. Positioned at the level of the crutch's lateral handle and in a forward beveled stance, this design allows users to disengage their hand from the lateral handle and insert their wrist into the curved portion of the “J” shaped structure. This setup enables the user to maneuver the crutch using primarily their bicep and wrist to apply counterpressure, thereby freeing the hand to carry items.

The detailed construction may include a solid flat rectangular “stem” structure that is vertically affixed to the base of the “J” shaped structure. This stem may be equipped with two holes for bolts that secure the entire assembly to the front of the crutch at the height of the lateral handle. The stem is bent where it connects to the “J” shaped structure, optimizing the forward bevel of the “J” shaped structure relative to the crutch. A version of the device without the “flat rectangular stem,” and also having only one hole where the bolt that secures the device to the crutch is inserted, is also contemplated and considered within the scope of the present disclosure. This arrangement allows the user to exert force through the wrist contact point, facilitating movement of the crutch off the ground and in the desired direction while keeping one hand free.

Further embodiments of the disclosure may vary the shape of the solid “J” structure to include oval, circular, squared, rectangular, horseshoe, meandering, triangular, or straight forms. These variations still allow the user to apply counterpressure with a portion of their arm to maneuver the crutch without needing to grip a handle.

In addition, the structure can be attached, attachable, built into, or otherwise connected to the crutch at various points to enhance versatility and user comfort. These points of attachment include the side, back, front, bottom, top, midpoint, or low point of the crutch. This flexibility allows the structure to be positioned in a manner that best suits the specific needs and preferences of the user, whether for ergonomic reasons, balance, or case of use. For instance, attaching the structure at the midpoint might provide optimal leverage for some users, while others might find a lower or higher placement more comfortable or effective depending on their height and mobility requirements. This design consideration ensures that the crutch can be customized to meet diverse user needs, enhancing functionality and user experience across a wide range of scenarios.

Furthermore, the present disclosure also contemplates various methods for attaching the structure to the crutch, ensuring versatility and ease of integration with existing crutch designs. The structure can be attached, attachable, built into, or otherwise connected to the crutch using a range of methods including but not limited to bolting, screwing, riveting, welding, cementing, clasping, gluing, wrapping, cinching, strapping, tying, slotting, or magnetizing. This wide array of attachment options provides flexibility in how the device can be customized and secured to different types of crutches, accommodating user preferences and specific requirements for stability and durability. These attachment methods are designed to ensure that the structure remains securely in place during use, providing reliable support and enhancing the overall functionality of the crutch.

Additionally, the structure and any associated components can be made from a variety of materials, each selected to optimize performance, durability, and user comfort. These materials include metals such as aluminum or steel, which provide strength and durability; plastics, which offer lightweight properties and flexibility; foam, which can enhance comfort through cushioning effects; and composites, known for their excellent strength-to-weight ratios. Furthermore, other suitable synthetic, natural, or hybrid materials may also be used depending on specific requirements such as weight, environmental resistance, and cost-effectiveness. The choice of material can significantly influence the functionality and user experience of the crutch, allowing for customization that meets a wide range of user needs from everyday mobility to specialized medical applications.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a block diagram illustrating a crutch device, according to some embodiments of the present disclosure.

FIG. 1B is a block diagram extending from FIG. 1A and further illustrating the crutch device, according to some embodiments of the present disclosure.

FIG. 2 is a block diagram illustrating an axillary crutch system having an axillary crutch and the crutch device of FIGS. 1A-1B, according to some embodiments of the present disclosure.

FIG. 3 is a block diagram illustrating a kit for installation of the crutch device on an axillary crutch, according to some embodiments of the present disclosure.

FIG. 4 is a flowchart illustrating a method of installing a crutch device to an axillary crutch, according to some embodiments of the present disclosure.

FIG. 5 is a top perspective view of a crutch device according to a particular embodiment of the present disclosure.

FIG. 6 is a bottom perspective view of a crutch device according to a particular embodiment of the present disclosure.

FIG. 7 is a top plan view of the crutch device shown in FIG. 5.

FIG. 8 is a bottom plan view of the crutch device shown in FIG. 5.

FIG. 9 is a front side elevational view of the crutch device shown in FIG. 5.

FIG. 10 is a rear side elevational view of the crutch device shown in FIG. 5.

FIG. 11 is a left side elevational view of the crutch device shown in FIG. 5.

FIG. 12 is a right side elevational view of the crutch device shown in FIG. 5.

FIG. 13 is a perspective view illustrating a kit for the crutch device according to one embodiment of the disclosure.

FIGS. 14A and 14B are perspective views illustrating a stepwise method for removing an elongate support structure from the crutch device, in accordance with one embodiment of the disclosure.

FIG. 15 is a perspective view illustrating a method for selectively rotating the elongate support structure of the crutch device, in accordance with one embodiment of the disclosure, to permit for use of the crotch under an other arm of the user.

FIG. 16 is a cross-sectional right side elevational view of the crutch device taken at section line A-A in FIG. 9.

FIG. 17 is a perspective view illustrating a use of the crutch device according to the present disclosure in operation and showing a user carrying an item while also using the crutch device.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the overall functionality and user experience of traditional axillary crutches by introducing ergonomic enhancements that allow for hands-free operation. By enabling users to perform tasks and carry items without the need to constantly grip the crutches, the technology fosters greater independence and mobility. Furthermore, the design incorporates lightweight, durable materials that maintain the stability and safety of the crutches, ensuring that users can confidently navigate various environments.

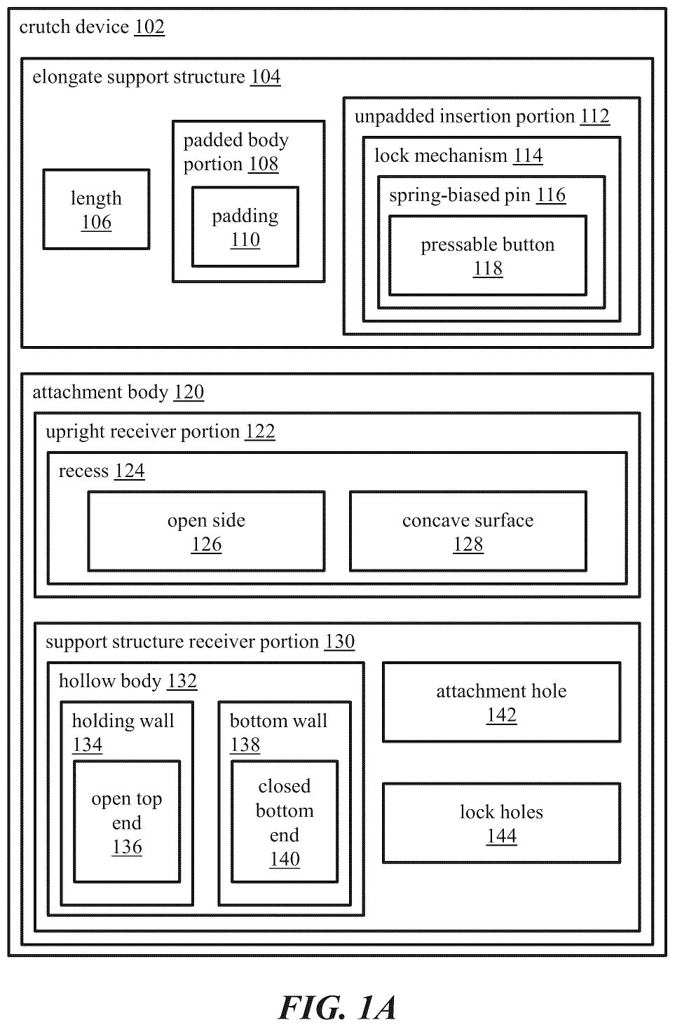

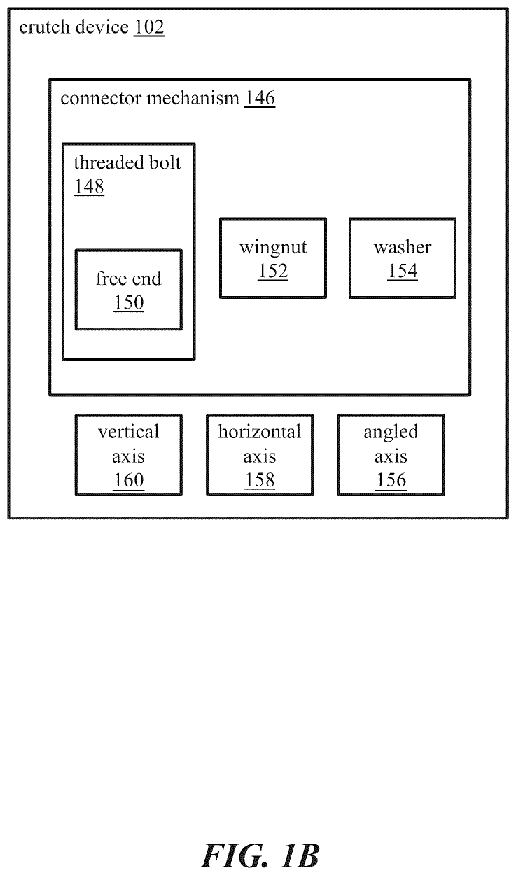

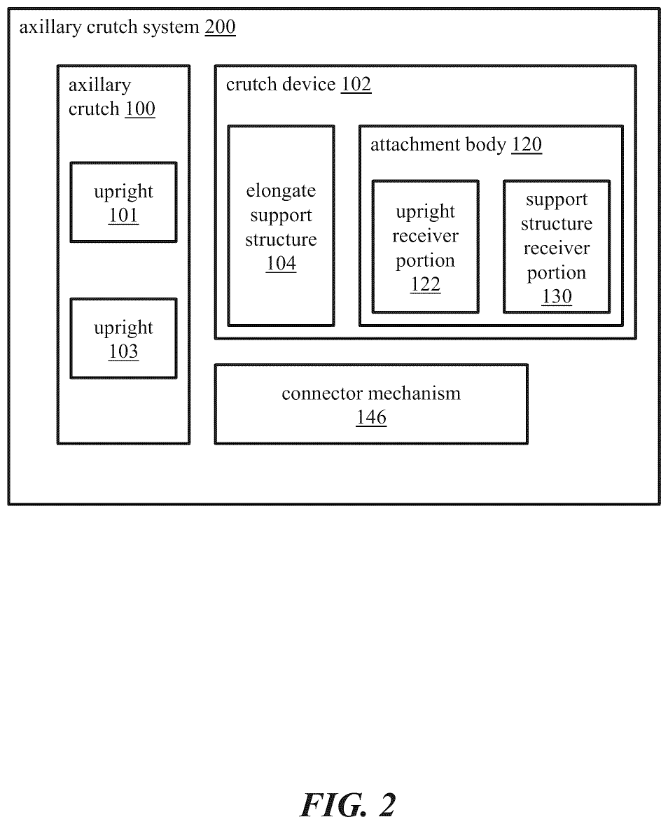

As shown in FIGS. 1A and 1B, the present disclosure relates to a crutch device 102 designed to facilitate hands-free carrying of items by a user of an axillary crutch 100 having at least one upright and a handle (identified herein as “101” and “103,” respectively, and shown in FIG. 2). The crutch device 102 may be particularly useful for individuals using axillary crutches who need to carry items while moving. The crutch device 102 may be provided as an accessory for use with the axillary crutch 100, or may be preinstalled or provided as integral with the axillary crutch 100, according to various embodiments further described herein. This device 102 may include an elongate support structure 104 and an attachment body 120, which collectively enhance the functionality of traditional axillary crutches.

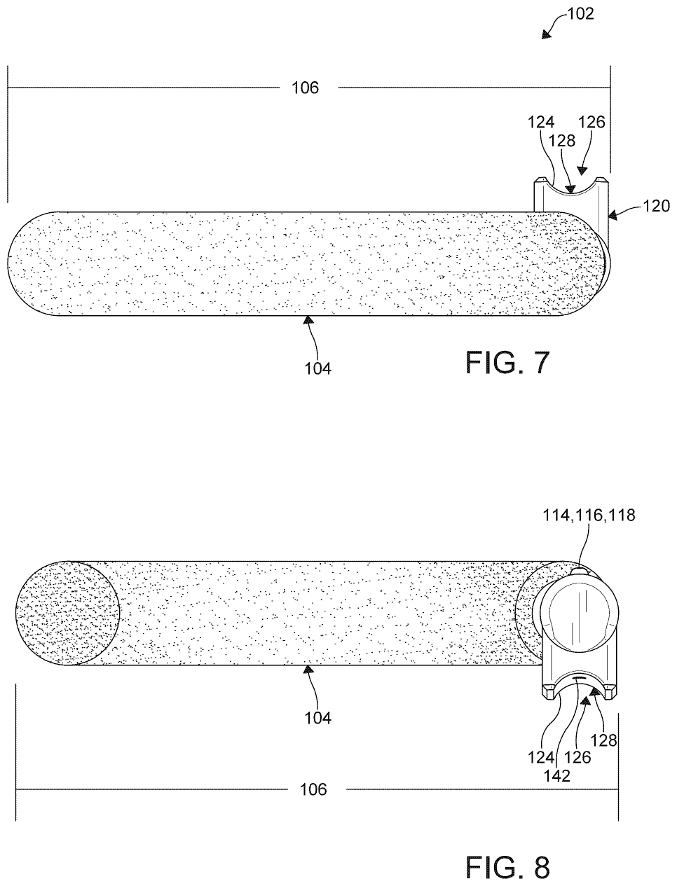

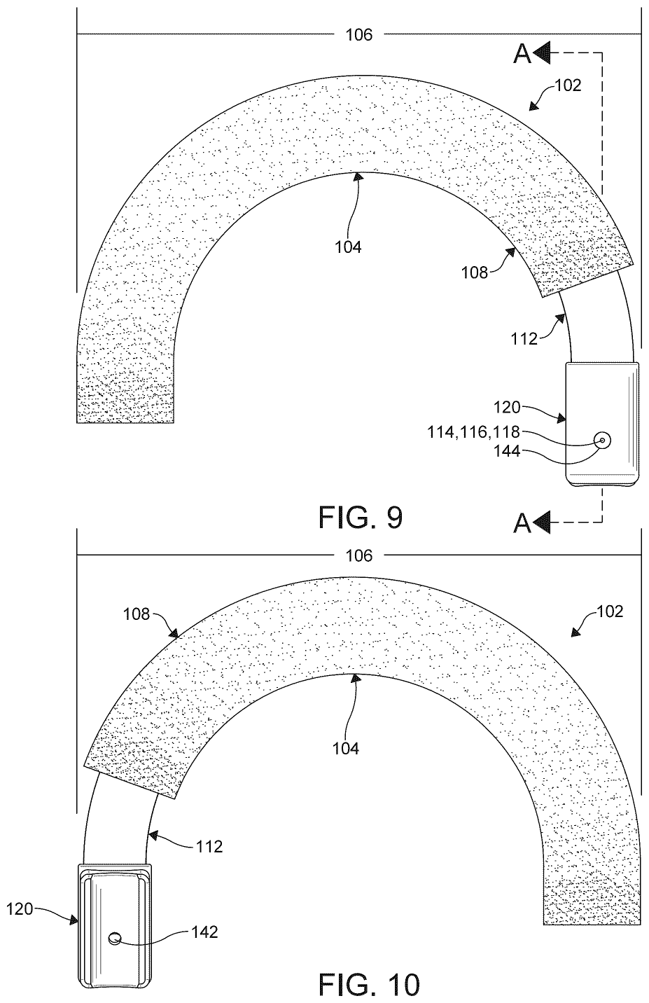

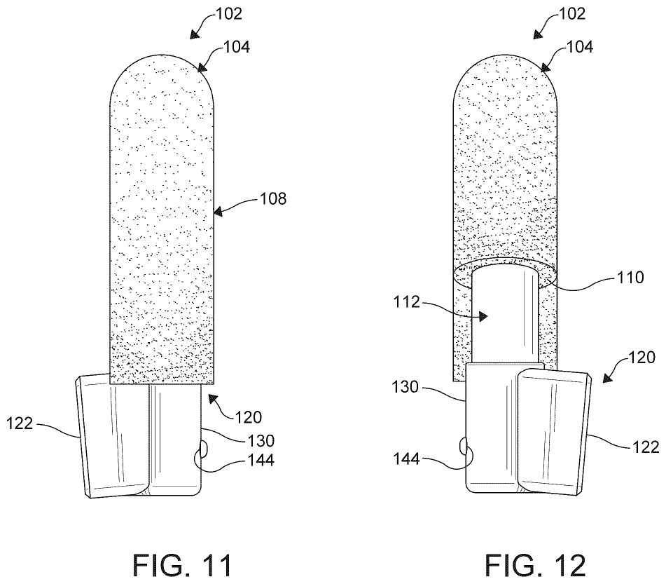

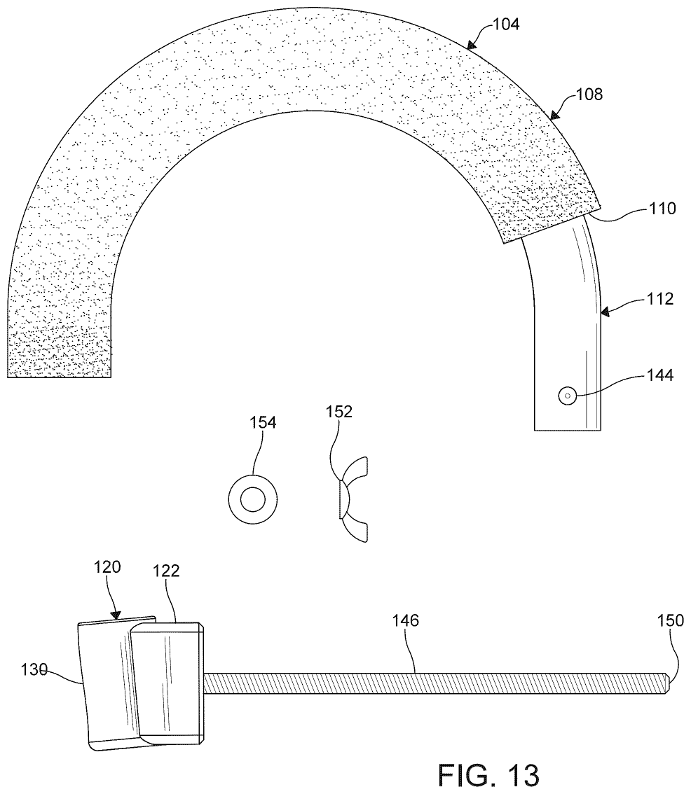

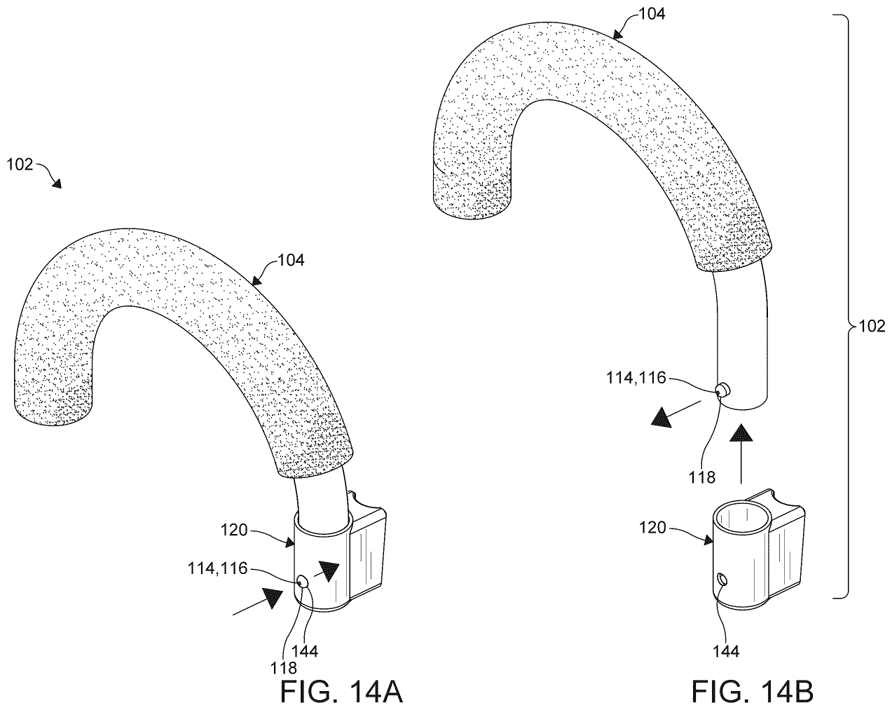

Referring now to FIGS. 1A to 16, the elongate support structure 104 of the crutch device 102 may be configured to ergonomically accommodate a portion of the arm of the user. The elongate support structure 104 may be provided in an ergonomic shape and is at least one of angled and curved along a length 106 of the elongate support structure 104 to ergonomically accommodate a portion of an arm of the user in operation. For example, the elongate support structure 104 may be formed in various shapes, such as substantially J-shaped, to provide comfortable and secure support. The ergonomic design of the elongate support structure 104 may help distribute the weight of the carried item evenly, reducing strain on the arm of the user.

The elongate support structure 104 may further include a padded body portion 108 with a padding 110 and an unpadded insertion portion 112 without the padding 110. The support structure receiver portion 130 may include a hollow main body 132. The unpadded insertion portion 112 may be disposed within and received by the support structure receiver portion 130 of the attachment body 120. The unpadded insertion portion may have a lock mechanism 114 that is configured to securely fix a position of the elongate support structure 104 within the attachment body 120, for example, as described further herein.

The attachment body 120 of the crutch device 102 may include an upright receiver portion 122 and a support structure receiver portion 130. The upright receiver portion 122 may be specifically configured to receive an upright 101 of an axillary crutch 100, ensuring a stable and secure connection between the crutch device 102 and the axillary crutch 100.

Advantageously, the upright receiver portion 122 receives an outer surface of just one of the uprights 101 of the axillary crutch 100, which spaced the crutch device 102 on one side of the crutch 100 and spaced apart from the other upright 101. In other words, the crutch device 102 in operation is not centered within the crutch 100 but is instead offset, which has been found to be advantageous in facilitating the use of crutch 100 in a hands-free manner.

The support structure receiver portion 130 of the attachment body 120 may be designed to receive the elongate support structure 104. This portion 130 may be disposed coaxially on an angled axis 156, aligning the elongate support structure 104 in a laterally-oriented position that is convenient for the user to access and use. It should be appreciated that the laterally-oriented position on just one of the uprights 101 (and not to the handle 103 of the axillary crutch 100) here is important for the use and operation of the crutch device 102, and also serves to differentiate the crutch device 102 from the prior art of Maulden et al., as described hereinabove, which does not position elongate support structure 104 in this manner.

More particularly, it is believed that the positioning and structural design of the elongate support structure 104 together significantly differentiate the crutch device 102 of the present disclosure from the prior art, specifically the design disclosed by Maulden et al. While the prior art utilizes a straight peg that extends perpendicularly from the crutch 100, the crutch device 102 employs an ergonomically shaped and curved or angled design, such as, for example, horseshoed or J-shaped structure. This curved or angled design is not only more ergonomic but also cradles the arm of the user, providing maximal contact and secure counterpressure. This feature is believed important as it enhances comfort and stability, allowing the user to easily insert and remove their arm without the discomfort associated with the rigid, straight peg of the prior art.

Furthermore, the position of attachment of the elongate support structure 104 also differentiating from Maulden et al. In the prior art, the support structure is fastened between the two pillars at the high end of the crutch, necessitating that the upper forearm be the primary point of contact. In contrast, the elongate support structure 104 is uniquely fastened to the front of the crutch, e.g., either by fasteners below the handle 103 or by replacing the fastener that normally travels through the handle 103. This innovative placement allows the lower forearm and wrist to be the points of contact, which is significantly more advantageous for the user in operation of the crutch device 102.

The positioning of the crutch device 102 at the same level as the handle of the crutch is also believed to optimize the ability of the user to utilize a fuller range of motion of the arm of the user effectively. This strategic placement allows the user to recruit their bicep muscle to lift the crutch, providing enough vertical clearance to ambulate comfortably and safely. This contrasts sharply with the design of the Maulden et al. prior art, which restricts the range of motion, potentially leading to shoulder strain and discomfort due to its higher and less accessible positioning. The crutch device 102 of the present disclosure provides an ergonomic efficiency and user comfort is enhanced significantly, making it a superior choice for users requiring mobility aids.

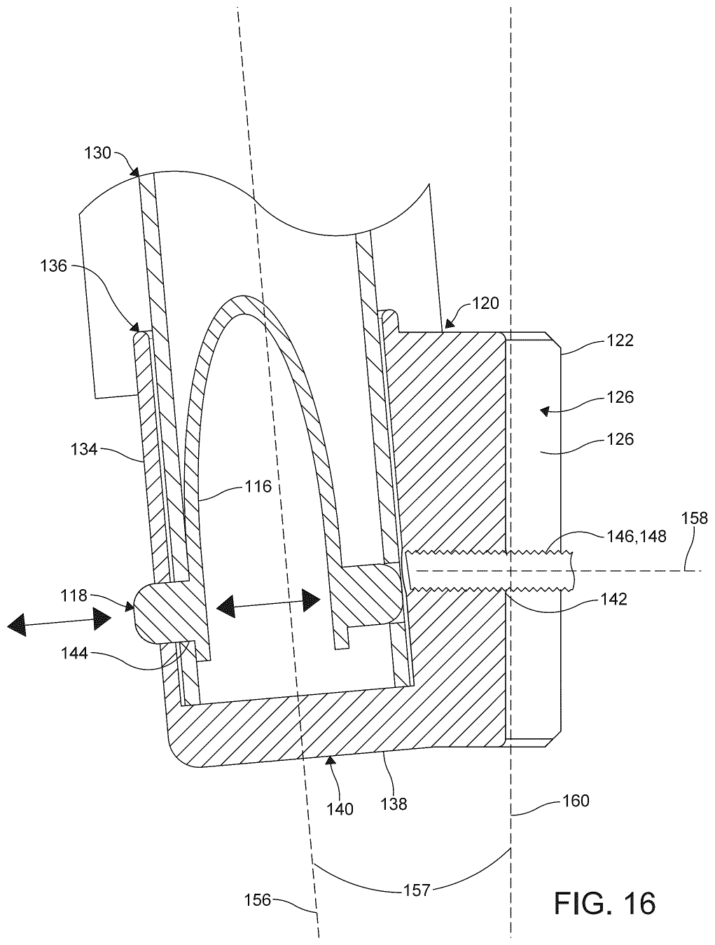

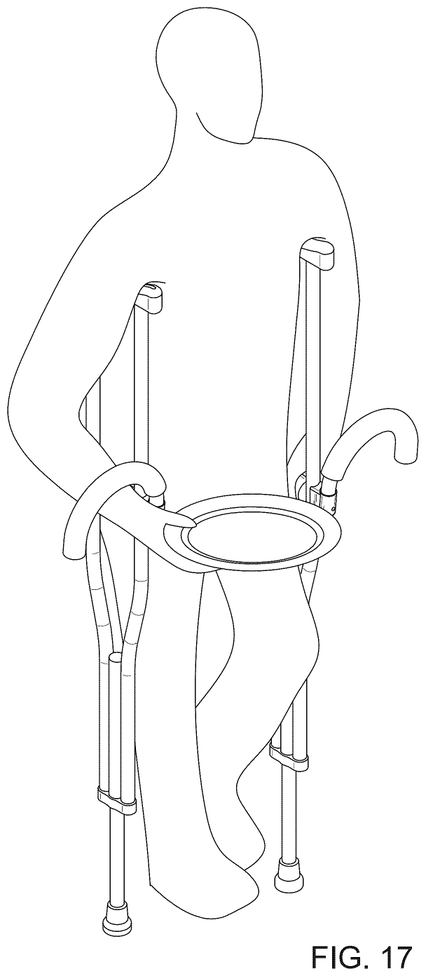

The upright receiver portion 122 may be disposed on a vertical axis 160, and the angled axis 156 may be oriented at an angle 157 (shown in FIG. 16) of between about one degree (1°) and about ten degrees (10°) relative to the vertical axis 160. This angled positioning may help in aligning the crutch device 102 with the natural angle of the user's arm, enhancing comfort and usability.

More particularly, the angled axis 156 of the support structure receiver portion 130 may be oriented at an angle of between about three degrees (3°) and about seven degrees (7°) relative to the vertical axis 160. This specific range may provide an optimal balance between stability and ergonomic benefit.

Most particularly, the angled axis 156 of the support structure receiver portion 130 may be oriented at about five degrees (5°) relative to the vertical axis 160. This precise orientation may be chosen to maximize the ergonomic benefits while minimizing any awkwardness or discomfort during use.

The attachment body 120 may further include an attachment hole 142 formed through both the upright receiver portion 122 and the support structure receiver portion 130. The attachment hole 142 may be arranged on a horizontal axis 158 that is orthogonal to the angled axis 156, facilitating the attachment of the crutch device 102 to the axillary crutch 100 using a connector mechanism 146. The connector mechanism 146 is configured for adjustable attaching of the attachment body 120 along the upright of the axillary crutch 100 and positioning of the elongate support structure 104 in the laterally-oriented position.

In certain embodiments, the connector mechanism 146 may include a threaded bolt 148 disposed through both the elongate support structure 104 and the attachment body 120. Although the attachment hole 142 is show open in most views, it should be appreciated that the attachment hole may be provided with the threaded bolt 148 already threadably installed in the attachment hole 142, and affixed, for example, with adhesive, welding, or the like.

The threaded bolt 148 may have a free end 150. The connector mechanism 146 may further include a wingnut 152 threadably attached to the free end 150 of the threaded bolt 148 for securing the crutch device 102 at a selected position to the upright of the axillary crutch 100. The connector mechanism 146 may further have a washer 154 disposed between the wingnut 152 and the attachment body 120.

Although the connector mechanism 146 is described and shown herein primarily with respect to the combination of the threaded bolt 148, the wingnut 152, and the washer 154, it should be appreciated that other suitable types of the connector mechanism 146 are also contemplated and considered to be within the scope of the present disclosure.

The support structure receiver portion 130 may have a plurality of lock holes 144. The lock holes 144 may be arranged around the support structure receiver portion 130 and permit for a selective rotation and holding of the elongate support structure 104 in the laterally-oriented position by the lock mechanism 114 regardless of the axillary crutch being a right-handed crutch or a left-handed crutch.

The lock mechanism 114, which may be a spring-biased pin 116 disposed adjacent a free end of the elongate support structure 104, for example, may be selectively received by one of the lock holes 144 in the support structure receiver portion 130. The spring-biased pin 116 maybe in the form of a leaf-spring inserted into a hold end of the elongate support structure 104, for example. The spring-biased pin 116 may also define a pressable button 118 that permits for rotation of the elongate support structure 104 within the attachment body 120 when the pressable button 118 is depressed by the user, and which does not permit for rotation of the elongate support structure 104 within the attachment body 120 when the pressable button 118 is not depressed. It should be appreciated that the lock mechanism 114 may secure the elongate support structure 104 in a desired laterally-oriented position, providing additional stability and security in operation.

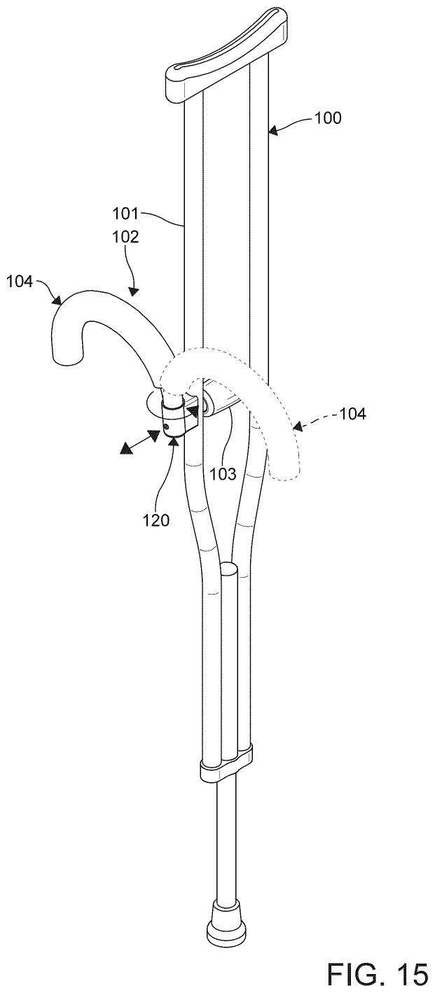

In a particular embodiment, the spring-biased pin 116 may define a pair of the pressable buttons 118, each disposed on opposite ends of the leaf-spring, and which permit for a selective locking of the elongate support structure 104 in two different positions oriented 180° relative to each other, for example, as shown in FIGS. 15 and 16.

The upright receiver portion 122 may comprise a recess 124 having an open side 126 and a concave surface 128. This configuration may allow the upright 101 of the axillary crutch 100 to be easily inserted and securely held within the upright receiver portion 122.

In particular embodiments, the elongate support structure 104 may be configured as a cup, including a closed bottom end 140 with a bottom wall 138, an opened top end 136, and a holding wall 134 disposed therebetween. The holding wall 134 may define the opened top end 136, providing a secure area for holding items.

As shown in FIG. 2, an axillary crutch system 200 may include the crutch device 102 as described. This system 200 may enhance the functionality of traditional axillary crutches by allowing the user to carry items hands-free while using the axillary crutch 100.

The axillary crutch system 200 may include a pair of axillary crutches, each equipped with the crutch device 102. This configuration may provide balanced support and increased functionality for the user.

In some embodiments, the crutch device 102 may be integrally formed with the axillary crutches of the system 200. This integration may provide a seamless and robust design that is both aesthetically pleasing and functionally superior.

Alternatively, the crutch device 102 may be detachable from the axillary crutches in the system 200. This feature may allow users to easily attach or detach the crutch device 102 as needed, providing flexibility in usage.

The crutch device 102 may be color-matched to the axillary crutches in the system 200. This color matching may provide a uniform and appealing appearance, enhancing the aesthetic value of the system 200.

Additionally, the crutch device 102 may include reflective materials for enhanced visibility. This feature may be particularly useful in low-light conditions, improving safety for the user.

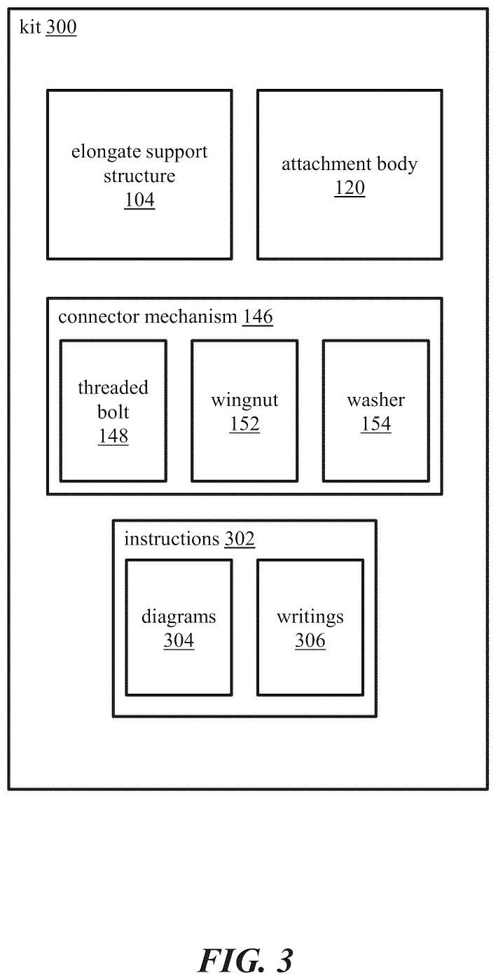

As shown in FIG. 3, a kit 300 for the crutch device 102 may be provided for hands-free carrying of items by a user. This kit 300 may include the elongate support structure 104, the attachment body 120, a threaded bolt 148, and a nut, configured for installation on an axillary crutch 100 to enable hands-free carrying of items by the user.

The elongate support structure 104 in the kit 300 may be pre-formed in a specific ergonomic shape to suit different user arm sizes. This pre-forming may ensure that the elongate support structure 104 provides optimal support and comfort for users with varying arm sizes.

The attachment body 120 in the kit 300 may include multiple attachment points for adjustable installation. These multiple points may allow users to customize the positioning of the crutch device 102 on the axillary crutch 100, according to their specific needs and preferences.

The threaded bolt 148 and the wingnut 152 in the kit 300 may be made of stainless steel for corrosion resistance. This material choice may ensure the durability and longevity of these components, even under conditions of frequent use and exposure to elements.

The kit 300 may further include an installation tool designed to assist in securing the threaded bolt 148 and nut. The installation tool may facilitate the installation process, making it easier and more efficient for users to attach the crutch device 102 to the axillary crutch 100.

Additionally, the kit 300 may include instructions 302 for installation, comprising diagrams 304 and writings 306 having step-by-step guidance. The instructions 302 may help users correctly and safely install the crutch device 102, ensuring optimal performance and safety.

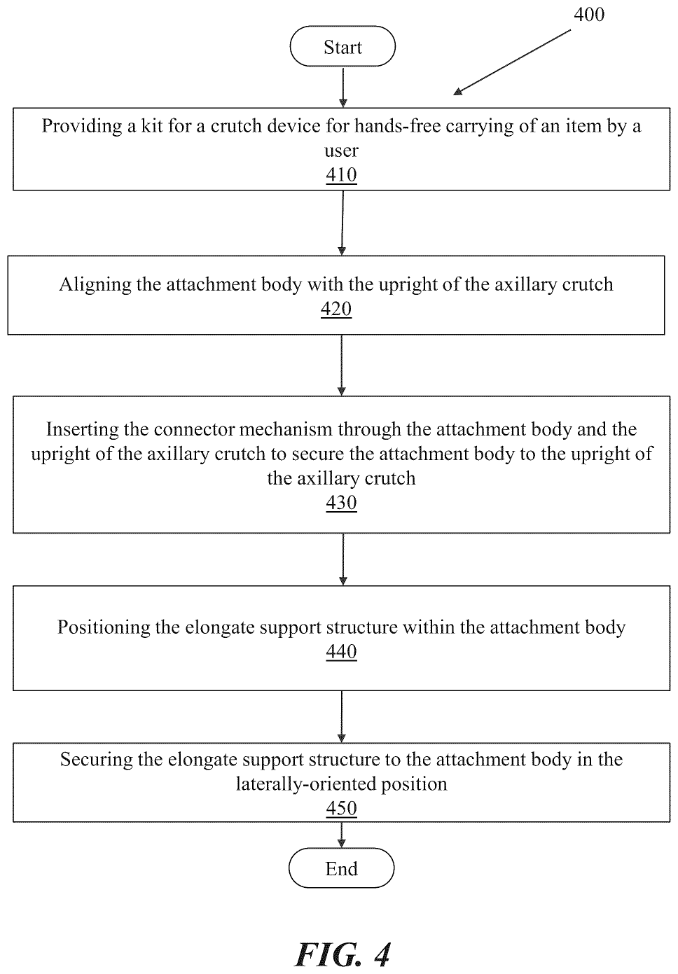

As shown in FIG. 4, a method 400 of installing the crutch device 102 to an axillary crutch may involve providing a kit 300 containing the necessary components, for example, as described hereinabove. This method 400 may facilitate the attachment of the crutch device 102 to the axillary crutch 100, allowing the user to carry items hands-free.

In the method 400, a first step 410 of aligning the attachment body 120 with the upright 101 of the axillary crutch 100 may be included. The first step 410 may involve positioning the upright receiver portion 122 of the attachment body 120 at an angle of about 5 degrees relative to the upright 101, optimizing the ergonomic alignment.

A second step 420 of inserting the threaded bolt 148 through the attachment hole 142 on a horizontal axis 158 in the attachment body 120 may be performed. The second step 420 may secure the attachment body 120 to the axillary crutch 100, providing a stable base for the elongate support structure 104.

A third step 430 of securing the threaded bolt 148 with the nut may follow, ensuring that the attachment body 120 is firmly attached to the axillary crutch 100. This securing may militate against any unwanted movement or detachment of the crutch device 102 during use.

A fourth step 440 of positioning the elongate support structure 104 in the support structure receiver portion 130 of the attachment body 120 may be included. The fourth step 440 may involve inserting the elongate support structure 104 into the recess 124, which has an open side 126 and a concave surface 128, providing a secure and ergonomic fit.

A fifth step 450 of securing the elongate support structure 104 to the attachment body 120 may be performed. The fifth step 450 may involve engaging a spring-biased pin 116 located in one of the lock holes 144 in the support structure receiver portion 130, locking the elongate support structure 104 in place.

The method 400 may further include a step of adjusting the position of the attachment body 120 along the upright 101 of the axillary crutch 100 to accommodate the height preferences of the user. This adjustment may ensure that the crutch device 102 is positioned at an optimal height for comfortable and effective use by the user.

Advantageously, the crutch device 102, and associated system 200, kit 300, and method 400 of the present disclosure address the limitations of traditional axillary crutches by providing a device that enables hands-free operation and item carrying. This innovative solution significantly enhances user independence and quality of life by allowing users to carry items while operating the crutches, including household items like cups and plates, which they would otherwise need assistance with. Unlike prior art solutions that introduced complex mechanisms or compromised stability, the crutch device 102 of the disclosure offers a simple, ergonomic design that integrates seamlessly with existing crutches, and maintains the stability of the user, the crutches, and the items being carried while in use. The crutch device 102 not only alleviates the need for users to rely on others but also promotes a more active and self-sufficient lifestyle during recovery periods.

### EXAMPLES

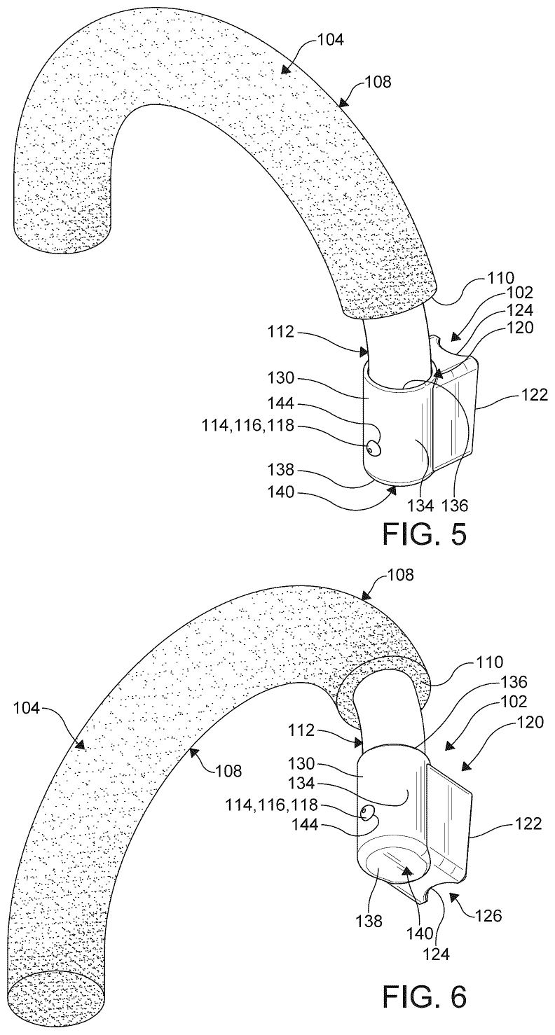

Example embodiments of the present technology are provided with reference to the several figure including FIGS. 5-17 enclosed herewith.

### Example 1: Installation and Use of the Crutch Device

In this example, a user purchases the kit for the crutch device to enhance their existing axillary crutches. The kit includes an elongate support structure, an attachment body, a threaded bolt, and a wingnut. The user begins by aligning the attachment body with the upright of their axillary crutch, ensuring that the upright receiving portion is positioned at an optimal angle of about five (5) degrees relative to the upright. This angle helps align the device with the natural angle of the user's arm, improving comfort and usability.

Next, the user inserts the threaded bolt through the first hole on the horizontal axis in the attachment body. The bolt passes through the upright receiving portion and the support structure receiving portion, securing the attachment body to the axillary crutch. The user then tightens the nut on the opposite side, ensuring that the attachment body is firmly attached and stable. This step is crucial for maintaining the integrity and safety of the device during use.

Finally, the user positions the elongate support structure in the support structure receiving portion of the attachment body. The elongate support structure is designed as a cup with a closed bottom end, an opened top end, and a holding wall defining the opened top end. The user can easily place items such as a water bottle, mobile phone, or small bag into the cup, allowing for hands-free carrying while using the axillary crutch. This setup significantly enhances the user's mobility and independence, enabling them to perform tasks that would otherwise require free hands.

### Example 2: Daily Activities with the Axillary Crutch System

In this scenario, a user who has recently undergone foot surgery is using the axillary crutch system integrated with the crutch device. The system includes a pair of axillary crutches, each equipped with the crutch device, allowing the user to carry items hands-free. The user finds this feature particularly useful for carrying meals from the kitchen to the living room, as it eliminates the need for additional trips or assistance from others.

One morning, the user prepares a breakfast plate and a cup of coffee. Using the crutch device, the user carries the cup in their hand or puts it on the plate and carry the plate with the cup on it, all while using the axillary crutch in a hands-free manner. The stability and ergonomic design of the crutch device ensure that the coffee remains secure and spill-free while the user navigates from the kitchen to the living room. This ability to carry items safely and independently significantly improves the user's quality of life during recovery.

Throughout the day, the user utilizes the crutch device for various other tasks, such as carrying documents from one room to another and holding a phone while moving around the house. The reflective materials on the crutch device also enhance visibility, providing an additional safety feature during evening walks. The user appreciates the enhanced functionality and independence provided by the axillary crutch system, which allows for a more active and self-sufficient lifestyle during the recovery period.

### Example 3: Long-Term Benefits and Adjustability

In this example, a user has been relying on axillary crutches for several weeks due to a leg injury. Over time, the user has adjusted the position of the attachment body along the upright of the axillary crutch to better suit their changing needs and comfort levels. The kit's included installation tool and adjustable features allow the user to easily make these adjustments, ensuring that the crutch device continues to meet their needs effectively.

Initially, the user had positioned the elongate support structure lower on the crutch to accommodate seated tasks, such as working at a desk. As the user's mobility improved and they began to stand and walk more frequently, they adjusted the attachment body to a higher position. This adjustment improved the ergonomics of using the crutch while walking, reducing strain on the user's arms and shoulders.

The long-term use of the crutch device has allowed the user to maintain a higher level of independence and activity than would have been possible with traditional crutches. The user has been able to carry out daily activities, attend social events, and even return to work while still using the crutches. The simple, user-friendly design of the crutch device has made it an invaluable tool in the user's recovery, demonstrating the significant benefits of this innovative solution.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A crutch device for hands-free carrying of an item by a user, comprising:
an elongate support structure; and
an attachment body having
an upright receiver portion configured to receive an upright of an axillary crutch, and
a support structure receiver portion receiving the elongate support structure in a laterally-oriented position,
wherein the attachment body facilitates an attachment of the elongate support structure to the upright of the axillary crutch upon being installed, thereby enabling hands-free use of the axillary crutch.

2. The crutch device of claim 1, wherein the support structure receiver portion is arranged along an angled axis.

3. The crutch device of claim 2, wherein the upright receiver portion is arranged along a vertical axis, the angled axis oriented at an angle of between about one degree (1°) and about ten degrees (10°) relative to the vertical axis.

4. The crutch device of claim 3, wherein the angled axis of the support structure receiver portion is oriented at an angle of between about three degrees (3°) and about seven degrees (7°) relative to the vertical axis.

5. The crutch device of claim 4, wherein the angled axis of the support structure receiver portion is oriented at about five degrees (5°) relative to the vertical axis.

6. The crutch device of claim 5, wherein the attachment body has an attachment hole formed through both the upright receiver portion and the support structure receiver portion.

7. The crutch device of claim 6, wherein the attachment hole is arranged along a horizontal axis that is substantially orthogonal to the vertical axis.

8. The crutch device of claim 7, further comprising a connector mechanism, wherein the attachment hole receives the connector mechanism for adjustable attaching of the attachment body along the upright of the axillary crutch and positioning of the elongate support structure in the laterally-oriented position.

9. The crutch device of claim 8, wherein the connector mechanism includes a threaded bolt disposed through the attachment hole and both the elongate support structure and the attachment body.

10. The crutch device of claim 9, wherein the connector mechanism further includes a wingnut threadably attached to an end of the threaded bolt for securing the crutch device at a selected position to the upright of the axillary crutch.

11. The crutch device of claim 10, wherein the connector mechanism further includes a washer disposed between the wingnut and the attachment body.

12. The crutch device of claim 1, wherein the elongate support structure is provided in an ergonomic shape and is at least one of angled and curved along a length of the elongate support structure to ergonomically accommodate a portion of an arm of the user.

13. The crutch device of claim 12, wherein the elongate support structure is substantially J-shaped.

14. The crutch device of claim 1, wherein the upright receiver portion includes a recess configured for receiving the upright of the axillary crutch, the recess having an open side and a concave surface.

15. The crutch device of claim 1, wherein the upright receiver portion includes padding to militate against damage to the upright of the axillary crutch.

16. The crutch device of claim 1, wherein an unpadded insertion portion has a lock mechanism to configured to securely fix a position of the elongate support structure within the attachment body.

17. An axillary crutch system comprising:
an axillary crutch having an upright; and
a crutch device for hands-free carrying of an item by a user, including
an elongate support structure, and
an attachment body having
an upright receiver portion receiving the upright of the axillary crutch, and
a support structure receiver portion receiving the elongate support structure in a laterally-oriented position,
wherein the attachment body facilitates an attachment of the elongate support structure to the axillary crutch upon being installed, thereby enabling hands-free use of the axillary crutch.

18. A kit for a crutch device for hands-free carrying of an item by a user, comprising:
an elongate support structure;
an attachment body; and
a connector mechanism for adjustable attaching of the attachment body along an upright of an axillary crutch and positioning of the elongate support structure in a laterally-oriented position,
wherein the kit is configured for installation on the axillary crutch to enable the hands-free carrying of the item by the user.

19. The kit of claim 18, further comprising instructions for installation including diagrams and writings for step-by-step guidance.

20. A method of attaching a crutch device to an axillary crutch, comprising steps of:
providing a kit for a crutch device for hands-free carrying of an item by a user, having
an elongate support structure,
an attachment body, and
a connector mechanism for adjustable attaching of the attachment body along an upright of the axillary crutch and positioning of the elongate support structure in a laterally-oriented position,
wherein the kit is configured for installation on an axillary crutch to enable the hands-free carrying of the item by the user,
aligning the attachment body with the upright of the axillary crutch;
inserting the connector mechanism through the attachment body and the upright of the axillary crutch to secure the attachment body to the upright of the axillary crutch;
positioning the elongate support structure within the attachment body; and
securing the elongate support structure to the attachment body in the laterally-oriented position.
